(19) United States
(12) Patent Application Publication
(10) Pub. No.: US 2022/0391719 A1
(43) Pub. Date: Dec. 8, 2022

(54) SYSTEM AND METHOD OF BUILDING A PREDICTIVE AI MODEL FOR AUTOMATICALLY GENERATING A TABULAR DATA PREDICTION

(71) Applicant: Katam.ai Inc., Clyde Hill, WA (US)

(72) Inventors: Riham Mansour, Redmond, WA (US); Amit Mital, Bellevue, WA (US); Patrice Simard, Clyde Hill, WA (US)

(73) Assignee: Katam.ai Inc., Clyde Hill, WA (US)

(21) Appl. No.: 17/337,726

(22) Filed: Jun. 3, 2021

(51) Int. Cl. G06N 5/04; G06N 20/00

(52) U.S. Cl. CPC G06N 5/04; G06N 20/00

(57) ABSTRACT

A processor-implemented method includes (i) obtaining raw data and value of a parameter in a column of tabular data, (ii) defining, based on user input, a smart column with tabular data prediction generated from raw data, (iii) validating, based on user input, a first label and a second label corresponding respectively to a first and a second predefined category to obtain a first and a second user-validated label respectively, (iv) detecting error in training set of the predictive AI model when there is a mismatch between a value from predictive AI model and user-validated label, (v) automatically generating a formula for the tabular data prediction to fix the error in training set, (vi) validating the first formula data prediction based on user input to obtain a user-validated formula, and (vii) automatically generating a first tabular data prediction in the smart column using user-validated formula to some of the raw data.

### BACKGROUND

### Technical Field

Embodiments of this disclosure generally relate to predictive artificial intelligence (AI) models, and more particularly, to a method of building a predictive AI model for automatically generating a tabular data prediction.

### Description of the Related Art

Spreadsheets are the most common tool for storing, managing and manipulating tabular data among business users. A spreadsheet has formulas and macros that enable users to apply functions on selected cells. These functions have predefined behavior that limit the ability of the user to derive the hidden insights or predictions from the data. For example, if we want to have a column that can provide a level of confidence in a sales lead converging into a successful deal, that might be very hard, tedious, and error prone to implement with existing predefined functions.

Existing systems and devices implementing artificial intelligence (AI) models involving tabular data, in general, are trained on data sets to make predictions based on training provided to the AI models. However, even with the help of these AI models, the user may be required to enter a prohibitive number of labels to compute correct values using statistical methods. Accordingly, in light of the foregoing discussion, there exists a need to generate a reliable tabular data prediction without the user having to enter a large number of labels.

### SUMMARY

In view of the foregoing, embodiments herein provide a processor-implemented method of building a predictive artificial intelligence (AI) model, for automatically generating a tabular data prediction based on at least one user-validated label generated by the predictive AI model and at least one user-validated formula generated by the predictive AI model. The method includes (i) obtaining a plurality of raw data, each of at least one value of at least one parameter, in at least one column of tabular data, (ii) defining, based in part on a user input, a smart column that comprises the tabular prediction that is selected from at least a first predefined category and a second predefined category, wherein the tabular data prediction is generated based on at least some of the plurality of raw data, (iii) validating, based on an input of the user, a first label that corresponds to the first predefined category to obtain a first user-validated label, (iv) validating, based on an input of the user, a second label that corresponds to the second predefined category to obtain a second user-validated label, (v) detecting a first error in a training set of the predictive AI model when there is a mismatch between a value that is predicted by the predictive AI model, and a user-validated label, (vi) automatically generating with the predictive AI model, a first formula for the tabular data prediction to fix the first error in the training set of the predictive AI model, wherein the first formula comprises a first feature defined in the at least one column of the tabular data, (vii) validating the first formula for the tabular data prediction based on an input of the user to obtain a first user-validated formula, and (viii) automatically generating a first tabular data prediction in the smart column by applying the first user-validated formula to at least some of the plurality of raw data.

In some embodiments, the method further includes (i) validating, based on an input of the user, a third label, to obtain a third user-validated label, (ii) detecting a second error in a training set of the predictive AI model when there is a mismatch between a value that is predicted by the predictive AI model, and a user-validated label, and (iii) automatically generating, with the predictive AI model, a second formula for the tabular data prediction to fix the second error in the training set of the predictive AI model, wherein the second formula comprises a second feature defined in the at least one column of the tabular data.

In some embodiments, the method further includes (i) validating the second formula based on an input of the user to obtain a second user-validated formula, and (ii) automatically generating, with the predictive AI model. a second tabular data prediction by applying the second user-validated formula to at least some of the plurality of the raw data.

In some embodiments, the predictive AI model is interactively updated in real-time each time at least one label or at least one formula for the tabular data prediction is validated by the user.

In some embodiments, the method further includes improving a generalization accuracy of the predictive AI model by iteratively performing the steps of (i) automatically generating labels and validating the labels based on user inputs to obtain a plurality of user-validated labels, (ii) detecting errors in the training set of the predictive AI model when there is a mismatch between a value that is predicted by the predictive AI model, and a user-validated label, (iii) automatically generating formulas when the errors are detected in the training set, (iv) validating the formulas based on user inputs to obtain a plurality of user-validated formulas, and (v) applying at least some of the plurality of user-validated formulas on at least some of the plurality of the raw data to obtain tabular data predictions, wherein the steps are iterated to increase the generalization accuracy of the predictive model.

In some embodiments, the method further includes (i) receiving an input from the user to sort rows of the tabular data based on a priority for labeling, and (ii) sorting the rows of the tabular data based on an order of priority that is based on the amount of information available in the rows to improve an accuracy of the predictive AI model, wherein labels that correspond to rows that have a higher priority are validated by the user before rows that have a lower priority.

In some embodiments, the method further includes (i) receiving an input from the user to sort rows of the tabular data based on the tabular data prediction, and (ii) sorting the rows of the tabular data based on a confidence level of the tabular data prediction.

In some embodiments, the first formula is automatically generated based on the first user-validated label that corresponds to the first predefined category, the second user-validated label that corresponds to the second predefined category, and at least some of the plurality of raw data in the at least one column of the tabular data.

In another aspect, a system for building a predictive AI model, for automatically generating a tabular data prediction based on at least one user-validated label generated by the predictive AI model and at least one user-validated formula generated by the predictive AI model is provided. The system includes a processor and a non-transitory computer readable storage medium storing one or more sequences of instructions, which when executed by the processor, performs a method that includes (i) obtaining a plurality of raw data, each of at least one value of at least one parameter, in at least one column of tabular data, (ii) defining, based in part on a user input, a smart column that comprises the tabular prediction that is selected from at least a first predefined category and a second predefined category, wherein the tabular data prediction is generated based on at least some of the plurality of raw data, (iii) validating, based on an input of the user, a first label that corresponds to the first predefined category to obtain a first user-validated label, (iv) validating, based on an input of the user, a second label that corresponds to the second predefined category to obtain a second user-validated label, (v) detecting a first error in a training set of the predictive AI model when there is a mismatch between a value that is predicted by the predictive AI model, and a user-validated label, (vi) automatically generating with the predictive AI model, a first formula for the tabular data prediction to fix the first error in the training set of the predictive AI model, wherein the first formula comprises a first feature defined in the at least one column of the tabular data, (vii) validating the first formula for the tabular data prediction based on an input of the user to obtain a first user-validated formula, and (viii) automatically generating a first tabular data prediction in the smart column by applying the first user-validated formula to at least some of the plurality of raw data.

In some embodiments, the system further includes (i) validating, based on an input of the user, a third label, to obtain a third user-validated label, (ii) detecting a second error in a training set of the predictive AI model when there is a mismatch between a value that is predicted by the predictive AI model, and a user-validated label, and (iii) automatically generating, with the predictive AI model, a second formula for the tabular data prediction to fix the second error in the training set of the predictive AI model, wherein the second formula comprises a second feature defined in the at least one column of the tabular data.

In some embodiments, the system further includes (i) validating the second formula based on an input of the user to obtain a second user-validated formula, and (ii) automatically generating, with the predictive AI model. a second tabular data prediction by applying the second user-validated formula to at least some of the plurality of the raw data.

In some embodiments, the predictive AI model is interactively updated in real-time each time at least one label or at least one formula for the tabular data prediction is validated by the user.

In some embodiments, the system further includes improving a generalization accuracy of the predictive AI model by iteratively performing the steps of (i) automatically generating labels and validating the labels based on user inputs to obtain a plurality of user-validated labels, (ii) detecting errors in the training set of the predictive AI model when there is a mismatch between a value that is predicted by the predictive AI model, and a user-validated label, (iii) automatically generating formulas when the errors are detected in the training set, (iv) validating the formulas based on user inputs to obtain a plurality of user-validated formulas, and (v) applying at least some of the plurality of user-validated formulas on at least some of the plurality of the raw data to obtain tabular data predictions, wherein the steps are iterated to increase the generalization accuracy of the predictive model.

In some embodiments, the system further includes (i) receiving an input from the user to sort rows of the tabular data based on a priority for labeling, and (ii) sorting the rows of the tabular data based on an order of priority that is based on the amount of information available in the rows to improve an accuracy of the predictive AI model, wherein labels that correspond to rows that have a higher priority are validated by the user before rows that have a lower priority.

In some embodiments, the system further includes (i) receiving an input from the user to sort rows of the tabular data based on the tabular data prediction, and (ii) sorting the rows of the tabular data based on a confidence level of the tabular data prediction.

In some embodiments, the first formula is automatically generated based on the first user-validated label that corresponds to the first predefined category, the second user-validated label that corresponds to the second predefined category, and at least some of the plurality of raw data in the at least one column of the tabular data.

In yet another aspect, one or more non-transitory computer readable storage mediums storing one or more sequences of instructions, which when executed by one or more processors, causes a method of building a predictive AI model, for automatically generating a tabular data prediction based on at least one user-validated label generated by the predictive AI model and at least one user-validated formula generated by the predictive AI model is provided. The method includes (i) obtaining a plurality of raw data, each of at least one value of at least one parameter, in at least one column of tabular data, (ii) defining, based in part on a user input, a smart column that comprises the tabular prediction that is selected from at least a first predefined category and a second predefined category, wherein the tabular data prediction is generated based on at least some of the plurality of raw data, (iii) validating, based on an input of the user, a first label that corresponds to the first predefined category to obtain a first user-validated label, (iv) validating, based on an input of the user, a second label that corresponds to the second predefined category to obtain a second user-validated label, (v) detecting a first error in a training set of the predictive AI model when there is a mismatch between a value that is predicted by the predictive AI model, and a user-validated label, (vi) automatically generating with the predictive AI model, a first formula for the tabular data prediction to fix the first error in the training set of the predictive AI model, wherein the first formula comprises a first feature defined in the at least one column of the tabular data, (vii) validating the first formula for the tabular data prediction based on an input of the user to obtain a first user-validated formula, and (viii) automatically generating a first tabular data prediction in the smart column by applying the first user-validated formula to at least some of the plurality of raw data.

In some embodiments, the one or more non-transitory computer readable storage mediums storing the one or more sequences of instructions, which when executed by one or more processors, further causes improving a generalization accuracy of the predictive AI model by iteratively performing the steps of (i) automatically generating labels and validating the labels based on user inputs to obtain a plurality of user-validated labels, (ii) detecting errors in the training set of the predictive AI model when there is a mismatch between a value that is predicted by the predictive AI model, and a user-validated label, (iii) automatically generating formulas when the errors are detected in the training set, (iv) validating the formulas based on user inputs to obtain a plurality of user-validated formulas, and (v) applying at least some of the plurality of user-validated formulas on at least some of the plurality of the raw data to obtain tabular data predictions, wherein the steps are iterated to increase the generalization accuracy of the predictive model.

In some embodiments, the one or more non-transitory computer readable storage mediums storing the one or more sequences of instructions, which when executed by one or more processors, further causes (i) receiving an input from the user to sort rows of the tabular data based on a priority for labeling, and (ii) sorting the rows of the tabular data based on an order of priority that is based on the amount of information available in the rows to improve an accuracy of the predictive AI model, wherein labels that correspond to rows that have a higher priority are validated by the user before rows that have a lower priority.

In some embodiments, the one or more non-transitory computer readable storage mediums storing the one or more sequences of instructions, which when executed by one or more processors, further causes (i) receiving an input from the user to sort rows of the tabular data based on the tabular data prediction, and (ii) sorting the rows of the tabular data based on a confidence level of the tabular data prediction.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a computing environment in which a computing device is operable to build a predictive artificial intelligence (AI) model for automatically generating a tabular data prediction to be displayed on a spreadsheet program of a user device according to some embodiments herein;

FIG. 2 is a block diagram of the computing device of FIG. 1 according to some embodiments herein;

FIG. 3 is an exemplary screenshot of a spreadsheet program on the user device of FIG. 1 that illustrates defining a smart column according to some embodiments herein;

FIG. 4 is an exemplary screenshot of the spreadsheet program of FIG. 3 that generates a tabular data prediction using the predictive AI model according to some embodiments herein;

FIG. 5 is an interaction-type flow diagram that illustrates a method for building a predictive AI model, for automatically generating a tabular data prediction based on at least one user-validated label generated by the predictive AI model and at least one user-validated formula generated by the predictive AI model according to some embodiments herein;

FIG. 6 is a flow diagram that illustrates a method for building a predictive AI model, for automatically generating a tabular data prediction based on at least one user-validated label generated by the predictive AI model and at least one user-validated formula generated by the predictive AI model according to some embodiments herein; and

FIG. 7 is a block diagram of a schematic diagram of a device used in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

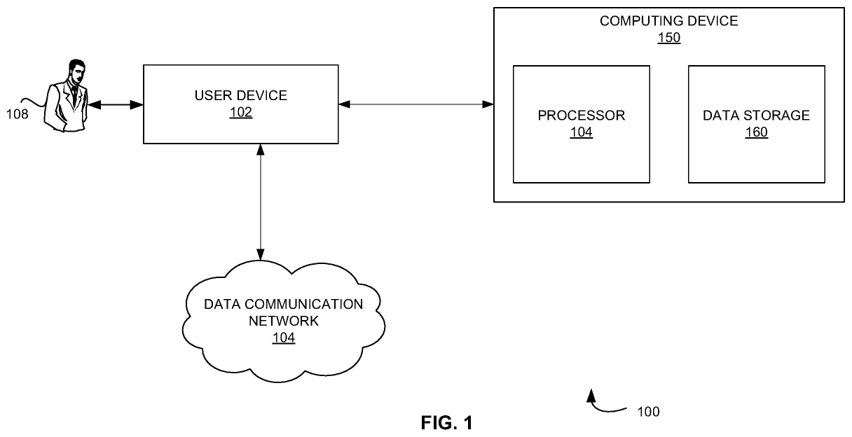

There remains a need for a system and method to build a predictive artificial intelligence (AI) model, for automatically generating a tabular data prediction, without the user having to enter a large number of labels. Referring now to the drawings, and more particularly to FIGS. 1 through 7, where similar reference characters denote corresponding features consistently throughout the figures, preferred embodiments are shown.

FIG. 1 is a block diagram that illustrates a computing environment 100 in which a computing device 150 is operable to build a predictive AI model for automatically generating a tabular data prediction to be displayed on a spreadsheet program of a user device 102 in accordance with an embodiment of the disclosure. The computing environment includes a user device 102, a computing device 150 having a processor 104 and a data storage 160, and a data communication network 106. In some embodiments, the data communication network 104 is a wired network. In some embodiments, the data communication network 104 is a wireless network. In some embodiments, the data communication network 104 is a combination of a wired network and a wireless network. In some embodiments, the data communication network 104 is the Internet.

The data storage 160 represents a storage for tabular data, which is accessed by the predictive AI model for automatically generating the tabular data prediction. The computing device 150 is operable to train the predictive AI model. The computing device 150 interacts with the data storage 160 while accessing the tabular data. The user device 102 receives inputs from the user 108 in a corresponding user interface on the user device 102 input values to validate one or more labels and formulae to obtain one or more user validated labels and user-validated formulae.

The computing device 150 may be configured to obtain a plurality of raw data, each of at least one value of at least one parameter, in at least one column of tabular data. The plurality of raw data may be tabular data such as a table, a spreadsheet, a set of records represented as rows or columns, or a dataset comprising rows and columns. The computing device 150 may obtain the plurality of raw data from the user 108 via the user device 102 and store it in the data storage 160, or obtain the plurality of raw data from the data storage 160 for display on a user interface of the user device 102.

The computing device 150 defines based at least in part on a user input, a smart column that includes the tabular prediction that is selected from at least a first predefined category and a second predefined category. The tabular data prediction is generated based on at least some of the plurality of raw data. In an embodiment, the first predefined category and the second predefined category may include data that may be binary or categorical in nature. The smart column may include a label column, a prediction column, a confidence score column and one or more automatic formula columns. The label column may include values that are validated based on an input of the user 108 from the user device 102. The confidence score column includes a confidence value for value in the prediction column. The confidence value is a score of confidence that is generated by the predictive AI model to quantify a confidence of the predictive AI model for the value in the prediction column. The confidence value may be a float value between 0 and 1. In an embodiment, the confidence value may be displayed as a percentage. The smart column may be populated based on at least some of the plurality of raw data. The computing device 150 may validate, based on an input of the user 108 from the user device 102, a first label that corresponds to the first predefined category to obtain a first user-validated label. The computing device 150 may validate, based on an input of the user 108 from the user device 102, a second label that corresponds to the second predefined category to obtain a second user-validated label. In some embodiments, the one or more automatic formulas may be a selection from a set of automatic formulas that fix the errors. The one or more automatic formulas may be suggested to the user 108. The user 108 may select a formula from the one or more automatic formulas that best fix the errors.

An error is detected when there is a mismatch of a record in a value in the label column and a value in the prediction column. The computing device 150 may detect a first error in a training set of the predictive AI model when there is a mismatch between a value that is predicted by the predictive AI model, and a user-validated label. The training set of the predictive AI model may be selected from the plurality of raw data.

The computing device 150 may automatically generate with the predictive AI model, a first formula for the tabular data prediction to fix the first error in the training set of the predictive AI model. The first formula may include a first feature defined in the at least one column of the tabular data. The computing device 150 may validate the first formula for the tabular data prediction based on an input of the user to obtain a first user-validated formula. The computing device 150 may automatically generate a first tabular data prediction in the smart column by applying the first user-validated formula to at least some of the plurality of raw data.

The computing device 150 is enabled to benefit from the hardware architecture including an optimized memory utilization for processing and thereby obtaining a higher processing speed. The system may iteratively perform the steps of a) assigning labels for a set of the tabular data to obtain pre-labelled data set, b) based on the pre-labelled data set, obtaining a user-validated data set by interactively validating the pre-labelled data set with the user 108, c) generating the prediction and d) subsequently updating the model based on the prediction until the AI model is able to meet a specific level of accuracy in generating the prediction for building the predictive AI model. The predictive AI model improves the accuracy in tabular data prediction, at least, for reasons similar to that illustrated above with respect to the algorithms to process historical data values. The pre-labelled data set is a dataset with associated labels that are generated by the computing device 150 before the user 108 sees the labels.

When the user 108 creates the smart column, the user may define two or more of the predefined categories associated with the smart column. In some embodiments, the computing device 150 provides the user 108 a functionality to add, delete or rename one or more of the two or more categories associated with the smart column. The predictive AI model automatically refreshes in real-time when any change occurs in a user validated label and/or a user validated formula.

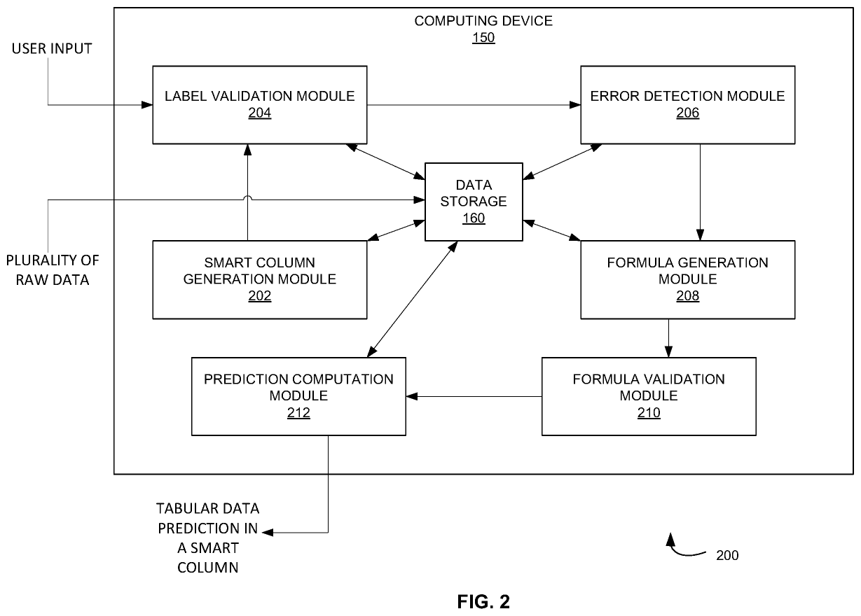

FIG. 2 is a block diagram of the computing device 150 of FIG. 1 according to some embodiments herein. The computing device 150 includes the data storage 160, a smart column generation module 202, a label validation module 204, an error detection module 206, a formula generation module 208, a formula validation module 210 and a prediction computation module 212. The data storage 160 obtains a plurality of raw data, each of at least one value of at least one parameter, in at least one column of tabular data. The label validation module 204 may be configured to define, based in part on a user input that may be obtained from the user 108 via the user device 102, a smart column that comprises the tabular prediction that is selected from at least a first predefined category and a second predefined category, where the tabular data prediction is generated based on at least some of the plurality of raw data. the label validation module 204 may enable the user 108 to enter desired values for a few selected rows of the plurality of raw data.

The label validation module 204 may validate, based on an input of the user 108 from the user device 102, a first label that corresponds to the first predefined category to obtain a first user-validated label. The label validation module 204 may further validate, based on an input of the user 108 from the user device 102, a second label that corresponds to the second predefined category to obtain a second user-validated label. The error detection module 206 may detect a first error in a training set of the predictive AI model when there is a mismatch between a value that is predicted by the predictive AI model, and a user-validated label. The training set of the predictive AI model may be selected from the plurality of raw data. the error detection module 206 may use a log loss function to detect errors in the training set of the predictive AI model. The log loss function is an objective function to minimize errors in the predictive AI model, to fit a log linear probability model to a set of binary labeled examples.

In some embodiments, one or more pre-labels may be generated automatically using the smart column generation module 202. Optionally, the one or more pre-labels may be edited based on the input from the user 108 to obtain user-validated labels.

The formula generation module 208 may automatically generate with the predictive AI model, a first formula for the tabular data prediction to fix the first error in the training set of the predictive AI model. A formula that is generated by the formula generation module 208 may include a predicate logic based on one or more features or columns of the plurality of raw data. In an embodiment, the one or more features or columns of the plurality of raw data include numerical data having one or more numerical values, for which the predicate logic may be based on a condition on a threshold of the one or more numerical values. In another embodiment, the one or more features or columns of the plurality of raw data include categorical data having one or more categorical values, for which the predicate logic may be based on the one or more categorical values. The first formula may include a first feature defined in the at least one column of the tabular data. The formula validation module 210 may validate the first formula for the tabular data prediction based on an input of the user to obtain a first user-validated formula.

In some embodiments, the smart column generation module 202 may validating, based on an input of the user, a third label, to obtain a third user-validated label. the error detection module 206 may detect a second error in a training set of the predictive AI model when there is a mismatch between a value that is predicted by the predictive AI model, and a user-validated label and the formula generation module 208 may automatically generate, with the predictive AI model, a second formula for the tabular data prediction to fix the second error in the training set of the predictive AI model, wherein the second formula comprises a second feature defined in the at least one column of the tabular data.

In an embodiment, the second formula may be validated based on the input of the user 108 to obtain a second user-validated formula. Further the prediction computation module 212 may generate, using the predictive AI model, a second tabular data prediction by applying the second user-validated formula to at least some of the plurality of the raw data.

The prediction computation module 212 may automatically generate a first tabular data prediction in the smart column by applying the first user-validated formula to at least some of the plurality of raw data.

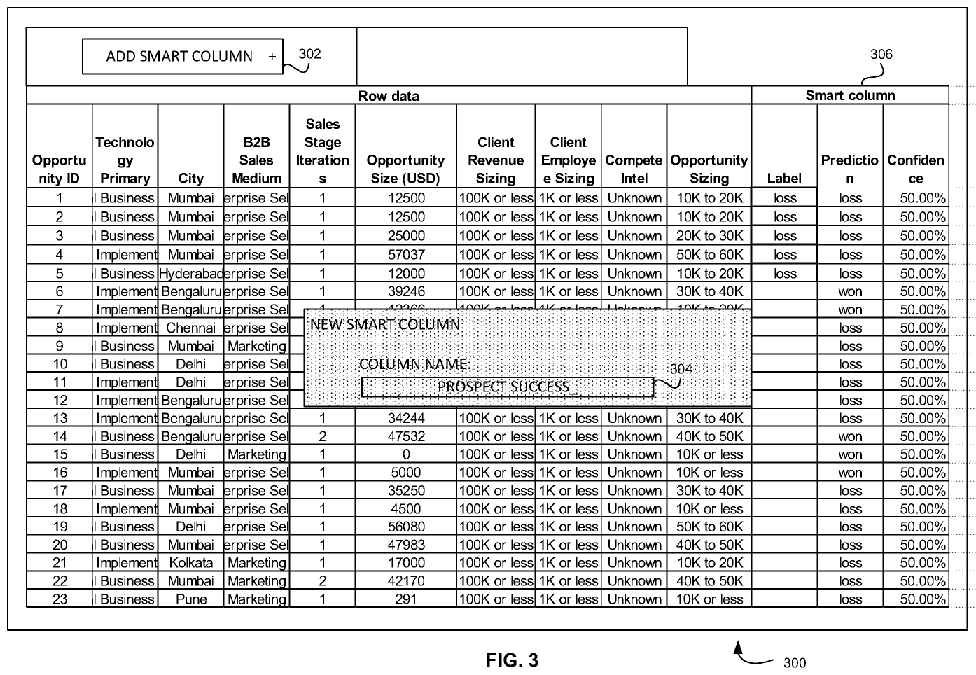

A plugin is a software component that adds a specific feature to an existing computer program. A spreadsheet program is be a computer application for organization, analysis, and storage of data in tabular form. The spreadsheet program may utilize the computing device 150 as a plugin for automatically generating a tabular data prediction based on at least one user-validated label generated by the predictive AI model and at least one user-validated formula generated by the predictive AI model, which is described in FIG. 3.

In some embodiments, the predictive AI model is interactively updated in real-time each time at least one label or at least one formula for the tabular data prediction is validated by the user 108.

A generalization accuracy is defined as a measure of how accurately the predictive AI model may predict outcome values for unseen data. The generalization accuracy of the predictive AI model by interactively by (i) automatically generating labels and validating the labels based on inputs from the user 108 to obtain a plurality of user-validated labels, (ii) detecting errors in the training set of the predictive AI model when there is a mismatch between a value that is predicted by the predictive AI model, and a user-validated label, (iii) automatically generating formulas when the errors are detected in the training set, (iv) validating the formulas based on user inputs to obtain a plurality of user-validated formulas, and (v) applying at least some of the plurality of user-validated formulas on at least some of the plurality of the raw data to obtain tabular data predictions, wherein the steps are iterated to increase the generalization accuracy of the predictive model.

FIG. 3 is an exemplary screenshot 300 of a spreadsheet program on the user device 102 of FIG. 1 that illustrates defining a smart column according to some embodiments herein. The screenshot 300 includes the spreadsheet program that displays a spreadsheet containing the plurality of raw data, an add smart column button 302, a new smart column prompt 304 and a smart column 306 that is added to the spreadsheet based on an input from the user 108 in the new smart column prompt 304. The spreadsheet, as an example, includes an entry of “opportunity ID” ranging from 1 to 23 and includes data related to different opportunities of sales for on employee of an organization. The spreadsheet program, via the plugin that is based on the computing device 150, provides a mechanism for the user 108 to define the smart column. As the user 108 clicks on the add smart column button 302, the user 108 is presented with the new smart column prompt 304. Upon inputting a name for the smart column as “prospect success”, which may relate to a prospected success of opportunities that are available in the plurality of raw data as different “opportunity ID”.

The plugin may add one or more new columns to the spreadsheet based on the input provided by the user 108 in the new smart column prompt 304. The plugin may generate a prompt on the user device 102 to enter one or more desired values for a few selected rows of the spreadsheet. The plugin may provide an ability for the user 108 to add or edit the one or more columns to the spreadsheet for improving a quality of the tabular data prediction based on automatically suggested formulas. The one or more desired values in the few selected rows, in combination with the ability for the user 108 to add or edit the one or more columns to the spreadsheet eliminates a requirement for processing a potentially large sampling dataset of the spreadsheet that has associated labels for training the predictive AI model, as opposed to the few selected rows of the spreadsheet.

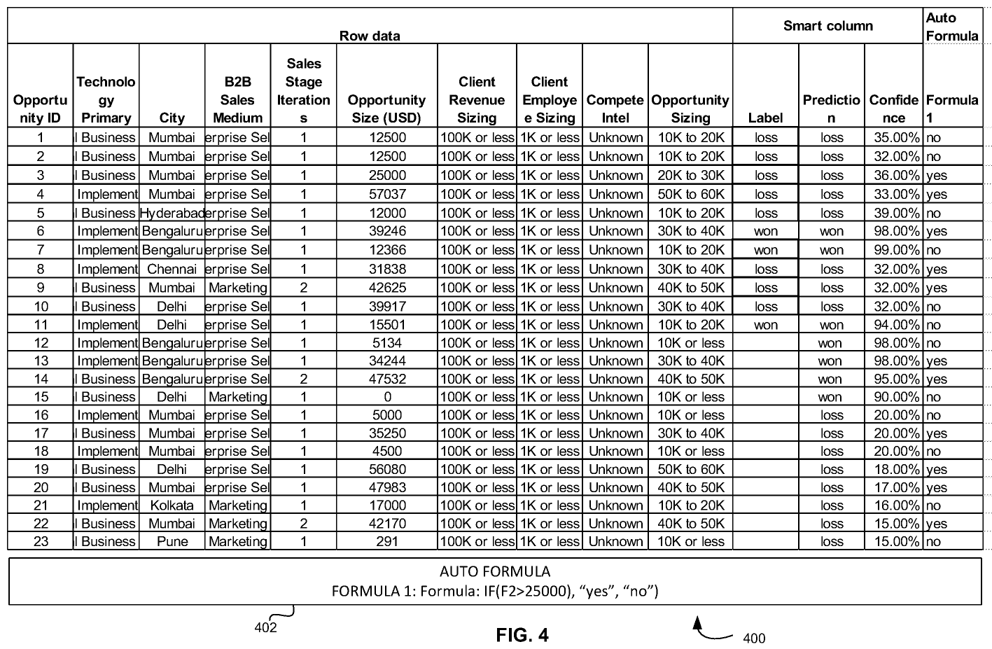

The first formula that may be generated using the predictive AI model is described in FIG. 4. The first formula may include a first feature defined in the at least one column of the tabular data.

In some embodiments, the first formula may be automatically generated based on the first user-validated label that corresponds to the first predefined category, the second user-validated label that corresponds to the second predefined category, and at least some of the plurality of raw data in the at least one column of the tabular data.

The one or more new columns may include a label column, the prediction column, the confidence score column and the one or more automatic formula columns. The smart column may be populated based on at least some of the plurality of raw data. Initially, the label column of the smart column is populated by the computing device 150 for opportunity ID 1 to 5. Each label for opportunity 1 to 5 has a confidence value of 50% in the beginning.

Based on an input of the user 108 from the user device 102, the labels are validated to obtain user-validated labels. The predictive AI model perform a first iteration of training based on data in rows having opportunity ID 1 to 5. After the first iteration of training, generates a tabular data prediction for populating the prediction column using the predictive AI model, which is described in FIG. 4.

FIG. 4 is an exemplary screenshot 400 of the spreadsheet program of FIG. 3 that generates a tabular data prediction using the predictive AI model according to some embodiments herein. The screenshot 400 illustrates the label column which is populated for opportunity ID 1 to 11 and the prediction column that is populated for opportunity ID 1 to 23. Based on the input of the user 108 from the user device 102, the label column is validated to obtain user-validated labels. The predictive AI model performs a second iteration of training based on the label column. After the second iteration of training, the predictive AI model populates the prediction column for opportunity ID 1 to 23. The predictive AI model may assign the confidence value to each opportunity ID. The confidence value is the score of confidence that is generated by the predictive AI model to quantify the confidence the predictive AI model for the value in the prediction column.

The mock-up screenshot 400 includes an auto formula banner 402 that displays the first formula. The auto formula banner displays the first formula as “FORMULA 1: Formula: IF(F2>25000), “yes”, “no”)” that results in a “yes” if the value in “opportunity size (USD)” column is greater than “25000”, else the first formula results in a “no”.

The first formula that may be generated using the predictive AI model is illustrated in mock-up screenshot 400 of the spreadsheet program. The first formula may include a first feature defined in the at least one column of the tabular data. In some embodiments, the first formula is automatically generated based on the first user-validated label that corresponds to the first predefined category, the second user-validated label that corresponds to the second predefined category, and at least some of the data in at least one column of the spreadsheet.

In some embodiments, the plugin may provide a sorting mechanism provides a suggestion to the user 108 about rows that may be prioritized to be labeled next.

In an embodiment, the plugin may receive an input from the user 108 to sort rows of the tabular data based on a priority for labeling. Upon receiving the input from the user, the plugin may sort the rows of the tabular data based on an order of priority that is based on the amount of information available in the rows to improve an accuracy of the predictive AI model, wherein labels that correspond to rows that have a higher priority are validated by the user before rows that have a lower priority. In another embodiment, the plugin may receive an input from the user to sort rows of the tabular data based on the tabular data prediction. Upon receiving the input from the user, the plugin may sort the rows of the tabular data based on a confidence level of the tabular data prediction.

The mock-up screenshot 400 shows a sorted tabular data for opportunity ID 12 to 23 with tabular data prediction that is sorted based on the tabular data prediction. The sorted tabular data is sorted based on the value of the confidence score column.

In some embodiments, the plugin may generate a collective formula using the predictive AI model for the spreadsheet. The collective formula may cover each of the one or more formulas generated so far by the predictive AI model for the spreadsheet.

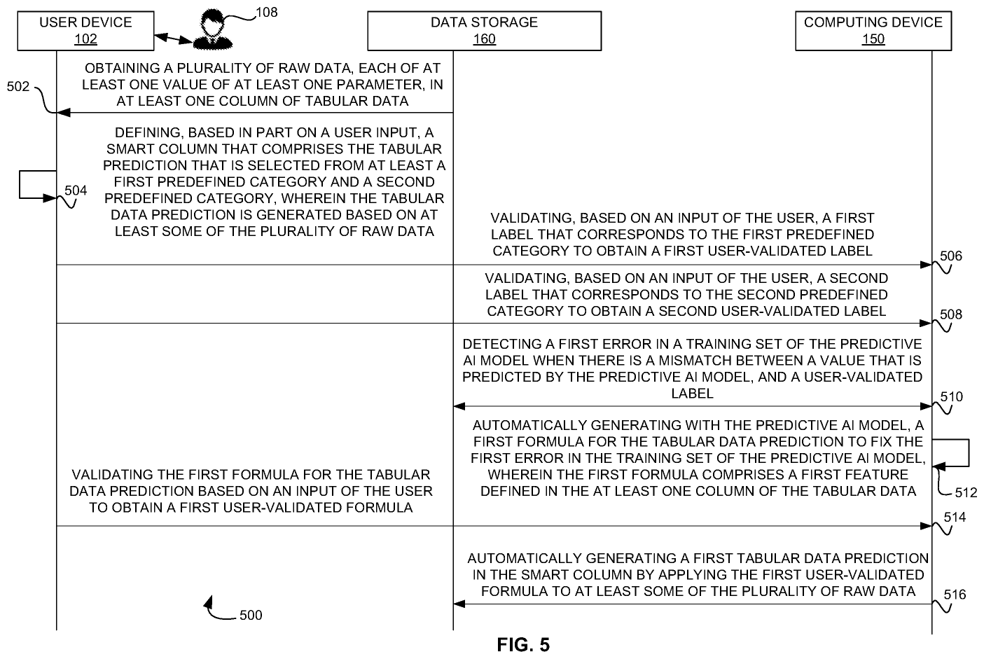

FIG. 5 is an interaction-type flow diagram that illustrates a method 500 of building a predictive AI model, for automatically generating a tabular data prediction based on at least one user-validated label generated by the predictive AI model and at least one user-validated formula generated by the predictive AI model according to some embodiments herein. At step 502, the method 500 includes obtaining a plurality of raw data, each of at least one value of at least one parameter, in at least one column of tabular data at the user device 102 from the data storage 160. At step 504, the method 500 includes defining at the user device 102, based in part on a user input from the user device 102, a smart column that comprises the tabular prediction that is selected from at least a first predefined category and a second predefined category, wherein the tabular data prediction is generated based on at least some of the plurality of raw data. At step 506, the method 500 includes validating from the user device 102, based on an input of the user, a first label that corresponds to the first predefined category to obtain a first user-validated label at the computing device 150. At step 508, the method 500 includes validating from the user device 102, based on an input of the user, a second label that corresponds to the second predefined category to obtain a second user-validated label at the computing device 150. At step 510, the method 500 includes detecting a first error in a training set of the predictive AI model when there is a mismatch between a value that is predicted by the predictive AI model, and a user-validated label. At step 512, the method 500 includes automatically generating at the computing device 150 with the predictive AI model, a first formula for the tabular data prediction to fix the first error in the training set of the predictive AI model, wherein the first formula comprises a first feature defined in the at least one column of the tabular data. At step 514, the method 500 includes validating from the user device 102, the first formula for the tabular data prediction based on an input of the user to obtain a first user-validated formula. At step 516, the method 500 includes automatically generating a first tabular data prediction in the smart column by applying the first user-validated formula to at least some of the plurality of raw data.

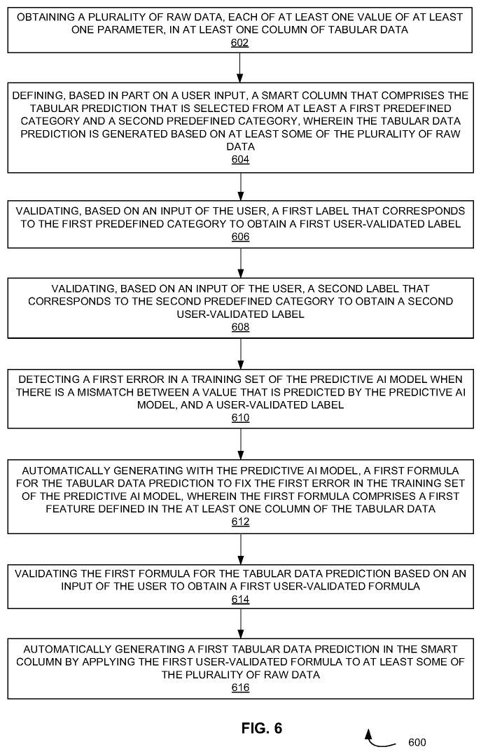

FIG. 6 is a flow diagram 600 that illustrates a method for building a predictive AI model, for automatically generating a tabular data prediction based on at least one user-validated label generated by the predictive AI model and at least one user-validated formula generated by the predictive AI model according to some embodiments herein. At step 602, the method 600 includes obtaining a plurality of raw data, each of at least one value of at least one parameter, in at least one column of tabular data. At step 604, the method 600 includes defining, based in part on a user input, a smart column that comprises the tabular prediction that is selected from at least a first predefined category and a second predefined category, wherein the tabular data prediction is generated based on at least some of the plurality of raw data. At step 606, the method 600 includes validating, based on an input of the user, a first label that corresponds to the first predefined category to obtain a first user-validated label. At step 608, the method 600 includes validating, based on an input of the user, a second label that corresponds to the second predefined category to obtain a second user-validated label. At step 610, the method 600 includes detecting a first error in a training set of the predictive AI model when there is a mismatch between a value that is predicted by the predictive AI model, and a user-validated label. At step 612, the method 600 includes automatically generating with the predictive AI model, a first formula for the tabular data prediction to fix the first error in the training set of the predictive AI model, wherein the first formula comprises a first feature defined in the at least one column of the tabular data. At step 614, the method 600 includes validating the first formula for the tabular data prediction based on an input of the user to obtain a first user-validated formula. At step 616, the method 600 includes automatically generating a first tabular data prediction in the smart column by applying the first user-validated formula to at least some of the plurality of raw data.

The embodiments herein may include a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

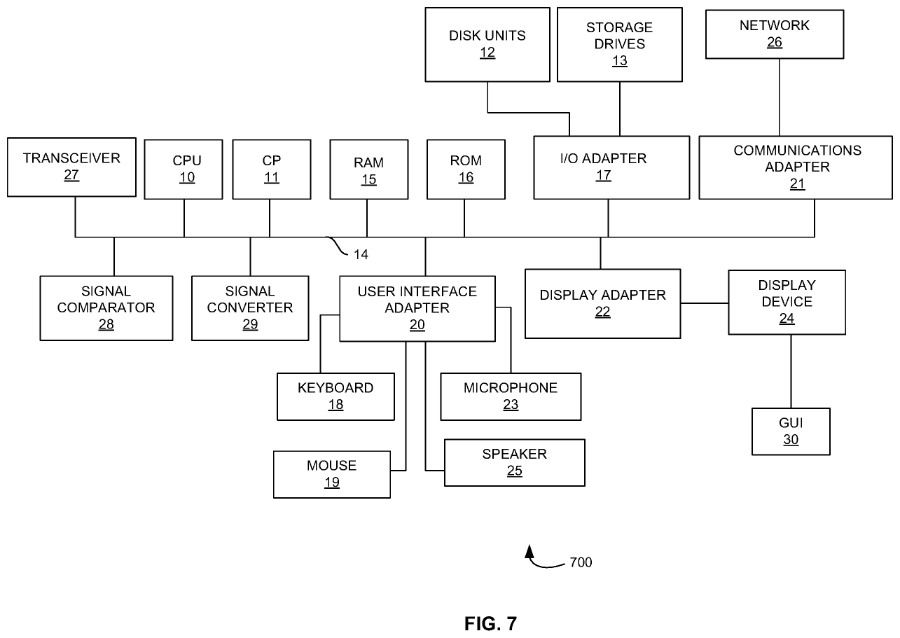

A representative hardware environment for practicing the embodiments herein is depicted in FIG. 7, with reference to FIGS. 1 through 6. This schematic drawing illustrates a hardware configuration of a server/computer system/user device in accordance with the embodiments herein. The user device includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The I/O adapter 17 can connect to peripheral devices, such as disk units 12 and tape drives 13, or other program storage devices that are readable by the system. The user device can read the inventive instructions on the program storage devices and follow these instructions to execute the methodology of the embodiments herein. The user device further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example. Further, a transceiver 27, a signal comparator 28, and a signal converter 29 may be connected with the bus 14 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method of building a predictive AI model, for automatically generating a tabular data prediction based on at least one user-validated label generated by the predictive AI model and at least one user-validated formula generated by the predictive AI model, comprising:
obtaining a plurality of raw data, each of at least one value of at least one parameter, in at least one column of tabular data;
defining, based in part on a user input, a smart column that comprises the tabular prediction that is selected from at least a first predefined category and a second predefined category, wherein the tabular data prediction is generated based on at least some of the plurality of raw data;
validating, based on an input of the user, a first label that corresponds to the first predefined category to obtain a first user-validated label;
validating, based on an input of the user, a second label that corresponds to the second predefined category to obtain a second user-validated label;
detecting a first error in a training set of the predictive AI model when there is a mismatch between a value that is predicted by the predictive AI model, and a user-validated label;
automatically generating with the predictive AI model, a first formula for the tabular data prediction to fix the first error in the training set of the predictive AI model, wherein the first formula comprises a first feature defined in the at least one column of the tabular data;
validating the first formula for the tabular data prediction based on an input of the user to obtain a first user-validated formula; and
automatically generating a first tabular data prediction in the smart column by applying the first user-validated formula to at least some of the plurality of raw data.

2. The processor-implemented method of claim 1 further comprising:
validating, based on an input of the user, a third label, to obtain a third user-validated label;
detecting a second error in a training set of the predictive AI model when there is a mismatch between a value that is predicted by the predictive AI model, and a user-validated label; and
automatically generating, with the predictive AI model, a second formula for the tabular data prediction to fix the second error in the training set of the predictive AI model, wherein the second formula comprises a second feature defined in the at least one column of the tabular data.

3. The processor-implemented method of claim 2, further comprising:
validating the second formula based on an input of the user to obtain a second user-validated formula; and
automatically generating, with the predictive AI model, a second tabular data prediction by applying the second user-validated formula to at least some of the plurality of the raw data.

4. The processor-implemented method of claim 1, wherein the predictive AI model is interactively updated in real-time each time at least one label or at least one formula for the tabular data prediction is validated by the user.

5. The processor-implemented method of claim 1, further comprising improving a generalization accuracy of the predictive AI model by iteratively performing the steps of:
automatically generating labels and validating the labels based on user inputs to obtain a plurality of user-validated labels;
detecting errors in the training set of the predictive AI model when there is a mismatch between a value that is predicted by the predictive AI model, and a user-validated label;
automatically generating formulas when the errors are detected in the training set;
validating the formulas based on user inputs to obtain a plurality of user-validated formulas; and
applying at least some of the plurality of user-validated formulas on at least some of the plurality of the raw data to obtain tabular data predictions, wherein the steps are iterated to increase the generalization accuracy of the predictive model.

6. The processor-implemented method of claim 1, further comprising:
receiving an input from the user to sort rows of the tabular data based on a priority for labeling; and
sorting the rows of the tabular data based on an order of priority that is based on the amount of information available in the rows to improve an accuracy of the predictive AI model, wherein labels that correspond to rows that have a higher priority are validated by the user before rows that have a lower priority.

7. The processor-implemented method of claim 1, further comprising:
receiving an input from the user to sort rows of the tabular data based on the tabular data prediction; and
sorting the rows of the tabular data based on a confidence level of the tabular data prediction.

8. The processor-implemented method of claim 1, wherein the first formula is automatically generated based on the first user-validated label that corresponds to the first predefined category, the second user-validated label that corresponds to the second predefined category, and at least some of the plurality of raw data in the at least one column of the tabular data.

9. A system for building a predictive AI model, for automatically generating a tabular data prediction based on at least one user-validated label generated by the predictive AI model and at least one user-validated formula generated by the predictive AI model comprising: a processor and a non-transitory computer readable storage medium storing one or more sequences of instructions, which when executed by the processor, performs a method comprising:
obtaining a plurality of raw data, each of at least one value of at least one parameter, in at least one column of tabular data;
defining, based in part on a user input, a smart column that comprises the tabular prediction that is selected from at least a first predefined category and a second predefined category, wherein the tabular data prediction is generated based on at least some of the plurality of raw data;
validating, based on an input of the user, a first label that corresponds to the first predefined category to obtain a first user-validated label;
validating, based on an input of the user, a second label that corresponds to the second predefined category to obtain a second user-validated label;
detecting a first error in a training set of the predictive AI model when there is a mismatch between a value that is predicted by the predictive AI model, and a user-validated label;
automatically generating with the predictive AI model, a first formula for the tabular data prediction to fix the first error in the training set of the predictive AI model, wherein the first formula comprises a first feature defined in the at least one column of the tabular data;
validating the first formula for the tabular data prediction based on an input of the user to obtain a first user-validated formula; and
automatically generating a first tabular data prediction in the smart column by applying the first user-validated formula to at least some of the plurality of raw data.

10. The system of claim 9, further comprising:
validating, based on an input of the user, a third label, to obtain a third user-validated label;
detecting a second error in a training set of the predictive AI model when there is a mismatch between a value that is predicted by the predictive AI model, and a user-validated label; and
automatically generating, with the predictive AI model, a second formula for the tabular data prediction to fix the second error in the training set of the predictive AI model, wherein the second formula comprises a second feature defined in the at least one column of the tabular data.

11. The system of claim 9, further comprising:
validating the second formula based on an input of the user to obtain a second user-validated formula; and
automatically generating, with the predictive AI model. a second tabular data prediction by applying the second user-validated formula to at least some of the plurality of the raw data.

12. The system of claim 11, wherein the predictive AI model is interactively updated in real-time each time at least one label or at least one formula for the tabular data prediction is validated by the user.

13. The system of claim 9, further comprising improving a generalization accuracy of the predictive AI model by iteratively performing the steps of:
automatically generating labels and validating the labels based on user inputs to obtain a plurality of user-validated labels;
detecting errors in the training set of the predictive AI model when there is a mismatch between a value that is predicted by the predictive AI model, and a user-validated label;
automatically generating formulas when the errors are detected in the training set;
validating the formulas based on user inputs to obtain a plurality of user-validated formulas; and
applying at least some of the plurality of user-validated formulas on at least some of the plurality of the raw data to obtain tabular data predictions, wherein the steps are iterated to increase the generalization accuracy of the predictive model.

14. The system of claim 9, further comprising:
receiving an input from the user to sort rows of the tabular data based on a priority for labeling; and
sorting the rows of the tabular data based on an order of priority that is based on the amount of information available in the rows to improve an accuracy of the predictive AI model, wherein labels that correspond to rows that have a higher priority are validated by the user before rows that have a lower priority.

15. The system of claim 9, further comprising:
receiving an input from the user to sort rows of the tabular data based on the tabular data prediction; and
sorting the rows of the tabular data based on a confidence level of the tabular data prediction.

16. The system of claim 9, wherein the first formula is automatically generated based on the first user-validated label that corresponds to the first predefined category, the second user-validated label that corresponds to the second predefined category, and at least some of the plurality of raw data in the at least one column of the tabular data.

17. One or more non-transitory computer readable storage mediums storing one or more sequences of instructions, which when executed by one or more processors, causes a method of building a predictive AI model, for automatically generating a tabular data prediction based on at least one user-validated label generated by the predictive AI model and at least one user-validated formula generated by the predictive AI model, the method comprising:
obtaining a plurality of raw data, each of at least one value of at least one parameter, in at least one column of tabular data;
defining, based in part on a user input, a smart column that comprises the tabular prediction that is selected from at least a first predefined category and a second predefined category, wherein the tabular data prediction is generated based on at least some of the plurality of raw data;
validating, based on an input of the user, a first label that corresponds to the first predefined category to obtain a first user-validated label;
validating, based on an input of the user, a second label that corresponds to the second predefined category to obtain a second user-validated label;
detecting a first error in a training set of the predictive AI model when there is a mismatch between a value that is predicted by the predictive AI model, and a user-validated label;
automatically generating with the predictive AI model, a first formula for the tabular data prediction to fix the first error in the training set of the predictive AI model, wherein the first formula comprises a first feature defined in the at least one column of the tabular data;
validating the first formula for the tabular data prediction based on an input of the user to obtain a first user-validated formula; and
automatically generating a first tabular data prediction in the smart column by applying the first user-validated formula to at least some of the plurality of raw data.

18. The one or more non-transitory computer readable storage mediums storing the one or more sequences of instructions of claim 17, further comprising improving a generalization accuracy of the predictive AI model by iteratively performing the steps of:
automatically generating labels and validating the labels based on user inputs to obtain a plurality of user-validated labels;
detecting errors in the training set of the predictive AI model when there is a mismatch between a value that is predicted by the predictive AI model, and a user-validated label;
automatically generating formulas when the errors are detected in the training set;
validating the formulas based on user inputs to obtain a plurality of user-validated formulas; and
applying at least some of the plurality of user-validated formulas on at least some of the plurality of the raw data to obtain tabular data predictions, wherein the steps are iterated to increase the generalization accuracy of the predictive model.

19. The one or more non-transitory computer readable storage mediums storing the one or more sequences of instructions of claim 17, further comprising:
receiving an input from the user to sort rows of the tabular data based on a priority for labeling; and
sorting the rows of the tabular data based on an order of priority that is based on the amount of information available in the rows to improve an accuracy of the predictive AI model, wherein labels that correspond to rows that have a higher priority are validated by the user before rows that have a lower priority.

20. The one or more non-transitory computer readable storage mediums storing the one or more sequences of instructions of claim 17, further comprising:
receiving an input from the user to sort rows of the tabular data based on the tabular data prediction; and
sorting the rows of the tabular data based on a confidence level of the tabular data prediction.
